(19) United States
(12) Patent Application Publication
(10) Pub. No.: US 2026/0050865 A1
(43) Pub. Date: Feb. 19, 2026

(54) METHOD AND SYSTEM FOR SHIPMENT DECISION AUTOMATION

(71) Applicant: Transfix, Inc., New York, NY (US)

(72) Inventors: Jonathan SALAMA, Hoboken, NJ (US); Eileen YANG, New York, NY (US)

(73) Assignee: Transfix, Inc., New York, NY (US)

(21) Appl. No.: 19/299,524

(22) Filed: Aug. 14, 2025

Related U.S. Application Data
(60) Provisional application No. 63/683,345, filed on Aug. 15, 2024.

(51) Int. Cl. G06Q 10/083

(52) U.S. Cl. CPC G06Q 10/083

(57) ABSTRACT

A method for automating shipment decisions is provided. The method includes receiving, from a freight broker user, an input of decision criteria. The method includes constructing a decision model based on the input of decision criteria. The method includes receiving a set of tender offers from shippers. The tender offers are each associated with a corresponding shipper and a corresponding shipment. The method includes applying the decision model to the set of tender offers received from the shippers, such that for each tender offer in the set of tender offers, the tender offer is accepted or rejected based on the decision model. The decision model includes one or more rules relating to attributes associated with the set of tender offers.

### CROSS REFERENCE TO RELATED APPLICATIONS

This application claims priority to U.S. Provisional Application No. 63/683,345, filed Aug. 15, 2024, which is incorporated by reference herein in its entirety for all purposes.

### TECHNICAL FIELD

Disclosed are embodiments related to methods and systems for shipment decision automation.

### BACKGROUND

Freight brokers need to respond to every tender received from their shippers (customers), so that those shippers know if the broker will coordinate the delivery of a shipment. This process is referred to as accepting or rejecting a shipment.

Operations teams within a brokerage are responsible for managing acceptance or rejection of each of these tenders. This can result in significant manual work for operations teams, spanning both high value decisioning to low value actioning as brokers can make hundreds of thousands of these decisions per week.

For medium-to-high volume freight brokers, for example, the amount of manual attention that must be given to incoming tender offers from shippers is burdensome. In this environment, it is difficult to effectively and optimally respond to each tender, taking into account various business concerns as well as practical considerations. Freight brokers have been handling this problem manually, in a time consuming and non-optimal way, for a long time.

### SUMMARY

Accordingly, there is a need in the field for improved decision making related to accepting or rejecting a shipment. There is also a need in the field for automating this decision making. This need has been long-felt, but despite the long-felt need, there are no existing solutions for automating the accept/reject of a shipment. In particular, there are no existing solutions for doing so in a way that empowers freight brokers to set their own criteria for accepting or rejecting a shipment, in a user-friendly way, which allows freight brokers to quickly and easily see the criteria for accepting or rejecting a shipment, to change those criteria as circumstances change, and to track the decisions made according to those criteria. Embodiments disclosed herein provide such a solution. In particular, embodiments provide for a tool to automate accepting or rejecting a shipment.

According to a first aspect, a method for automating shipment decisions is provided. The method includes receiving, from a freight broker user, an input of decision criteria. The method includes constructing a decision model based on the input of decision criteria. The method includes receiving a set of tender offers from shippers. The tender offers are each associated with a corresponding shipper and a corresponding shipment. The method includes applying the decision model to the set of tender offers received from the shippers, such that for each tender offer in the set of tender offers, the tender offer is accepted or rejected based on the decision model. The decision model includes one or more rules relating to attributes associated with the set of tender offers.

According to a third aspect, a node is provided. The node includes processing circuitry; and a memory. The memory contains instructions executable by the processing circuitry, whereby when executed the processing circuitry is configured to receive, from a freight broker user, an input of decision criteria. The processing circuitry is further configured to construct a decision model based on the input of decision criteria. The processing circuitry is further configured to receive a set of tender offers from shippers. The tender offers are each associated with a corresponding shipper and a corresponding shipment. The processing circuitry is further configured to apply the decision model to the set of tender offers received from the shippers, such that for each tender offer in the set of tender offers, the tender offer is accepted or rejected based on the decision model. The decision model includes one or more rules relating to attributes associated with the set of tender offers.

### BRIEF DESCRIPTION OF THE DRAWINGS

The accompanying drawings, which are incorporated herein and form part of the specification, illustrate various embodiments.

FIG. 1 illustrates a user interface according to some embodiments.

FIG. 2 illustrates a decision model according to some embodiments.

FIG. 3 illustrates a system according to some embodiments.

FIG. 4 illustrates a flowchart according to an embodiment.

FIG. 5 is a block diagram of an apparatus according to an embodiment.

### DETAILED DESCRIPTION

Freight brokers (or simply brokers) may consider many different criteria in making an accept/reject decision on a shipment. For example, brokers may be concerned with protecting margin goals and therefore, an operations team member might reject loads with a negative projected margin. Shippers may require a 100% acceptance rate for a specific rate type, and therefore an operations team member will accept all loads from that shipper. Brokers may also be required to accept a certain amount of volume based on agreed upon commitments with shippers. For example, Shipper A grants a 6-month long contract award, and specifies that the broker must accept a minimum of 3 shipments per week during that contract. An operations team member may take this into account when making an accept/reject decision. Brokerages may also be concerned with maintaining high service levels. Therefore, an operations team member might reject loads if carrier capacity is constrained and it is unlikely that the broker can deliver the shipment on time. Other requirements, including key performance indicators (KPIs), may be part of a contract that a broker has with a certain shipper, and an operations team member may take these other requirements, including KPIs, into account when accepting or rejecting a shipment.

Embodiments provided herein include an Accept/Reject Automation tool. Embodiments allow brokers to configure decision criteria that power the accept/reject decision making for the broker. This logic may be exposed through a user-facing front-end interface, allowing operations staff to define and track automation decisions made per shipper, based on attributes that can be defined and customized per broker as well as per shipper.

Exposing accept and reject logic in the front-end will allow freight broker users to understand whether automation exists for a given shipper. If automation does exist, users will be able to understand the logic behind the automation. This increases visibility and the self-serviceability of accept/reject.

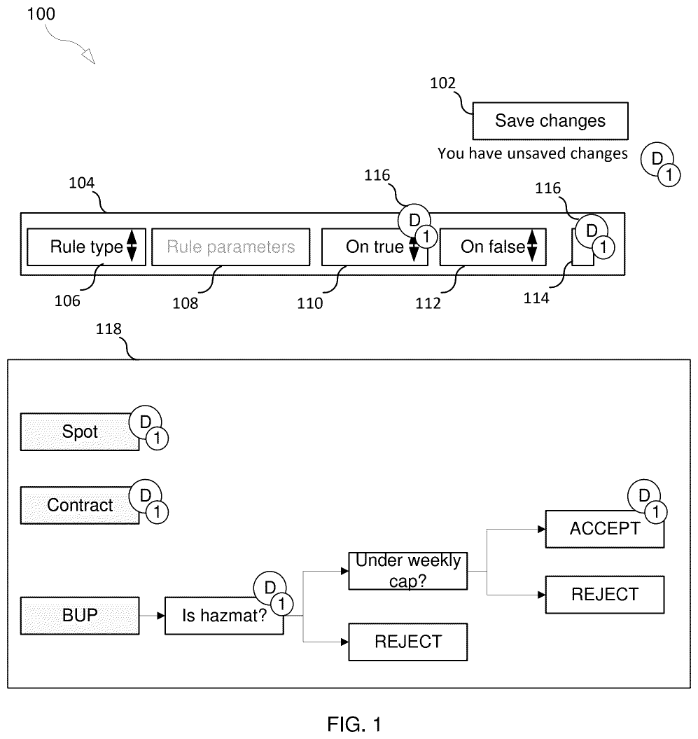

FIG. 1 illustrates a user interface according to an embodiment. User interface 100 allows a user to create a set of criteria for accepting or rejecting shipments. As shown, there is a save button 102, that allows a user to save any changes that may have been made. In embodiments, changes may be visually indicated; for example, by highlighting, or some other manner, of showing what has been added or modified. As shown, a change symbol 116 indicates elements that have been added or modified. A control panel 104 provides options to users to add or modify to the set of criteria for accepting or rejecting shipments. For example, a rule-type drop-down menu 106 may be provided, which allows a user to select from one or more rule types. A rule type may be a recommended action, for example. A rule of this rule type may be to take an action based on whether a shipment contains hazardous material (the “Is Hazmat” rule shown in the figure). There may be one or more parameters associated with a rule. These parameters may be associated with the rule by default, and a user may also be able to change the parameters, or specify additional parameters to associate with the rule, using the rule parameters drop-down menu 108. For example, with the “Is Hazmat” rule, a parameter may include whether the shipment contains hazardous materials. Another rule may be to accept a shipment if the target margin is above a threshold amount. Parameters associated with this rule may include the target margin for the shipment, and the threshold amount. The user may be able to adjust the threshold amount, for example, using the rule parameters drop-down menu 108. A given rule may have different actions depending on whether the result is true or false. For example, for the “Is Hazmat” rule, if it is true then the shipment may be rejected, and if it is false, the shipment may be accepted, or the user may insert another rule to consider before accepting the shipment. The “on true” drop-down menu 110 and “on false” drop-down menu 112 allow users to select actions for what happens when a rule is true or false, respectively. A delete button 114 may also allow users to delete a rule. In addition to accept or reject, one result may be “no action.” In embodiments, “no action” may be used to flag for a broker user that the automated decision criteria cannot reach a firm decision, and human input is needed.

The user interface 100 shows the current set of criteria for accepting or rejecting shipments in a work area 118. In embodiments, shipment tenders may be divided into three broad categories—spot tenders (one-off or short-term shipment orders), contract tenders (longer-term shipment orders), and backup/publish (BUP) tenders (non-guaranteed shipments where a rate with the shipper has been agreed outside of a primary contract award). Other categories, or variations of these categories, could also be used. Each tender offer is assigned to one of these categories. In effect, these categories constitute default rules, and in some embodiments, the decision criteria may begin at a different initial rule, and the rules may or may not treat different tender offer categories differently.

As shown in FIG. 1, the work area 118 includes “spot” and “contract” categories, but no rules for these categories have been implemented. In some embodiments, there may be default rules, such as always accept, or always reject, in the absence of user-supplied rules. For the “BUP” category, there are two rules shown, “Is hazmat?” and “Under weekly cap?” If “Is hazmat” is true, the shipment is rejected. Otherwise, the next rule checks to see if the broker is under its weekly cap of shipments. If true, then the shipment is accepted; otherwise, the shipment is rejected. The weekly cap may refer to a total cap on shipments, or to a per-shipper cap on shipments.

User interface 100 allows a user to see the rules in place in work area 118. This enables the user to understand what the decision criteria for accepting or rejecting shipments are, and also allows the user to add to or modify the decision criteria as appropriate.

As shown, the decision criteria in FIG. 1 are provided in the form of a hierarchical decision tree. There are separate trees each having its own root node for each of the tender categories (“spot,” “contract,” and “BUP”), though in some embodiments there may be a single tree with a single root node. Each node in the tree is shown as having two branches; one branch is taken if the result of the node is true, the other if the result of the node is false. For simplicity, the figure does not indicate which branch is taken for true, and which for false, though in embodiments the user interface 100 would indicate this, e.g., via labels on the arrows leading out from the node, via color or highlighting, or some other way. In embodiments, one or more of the nodes may have more than two branches. For example, instead of a binary result (true/false), the rule may have different actions for a range of values, such as a “low,” “medium,” or “high” profit margin. As another example, an initial root node may divide the shipments between the tender categories. Where those categories are “spot,” “contract,” and “BUP,” the node will branch into three nodes, each one being applied only to shipments within the corresponding category.

Based on decision criteria received from a user through user interface 100, a decision model may be created. For example, a decision tree, arranged in an hierarchical tree-like arrangement, such as illustrated in the figure, may be created. The decision model may be capable of applying the decision criteria to a set of tender offers and indicating a result of the decision model on each tender offer (e.g., accept, reject, or no action).

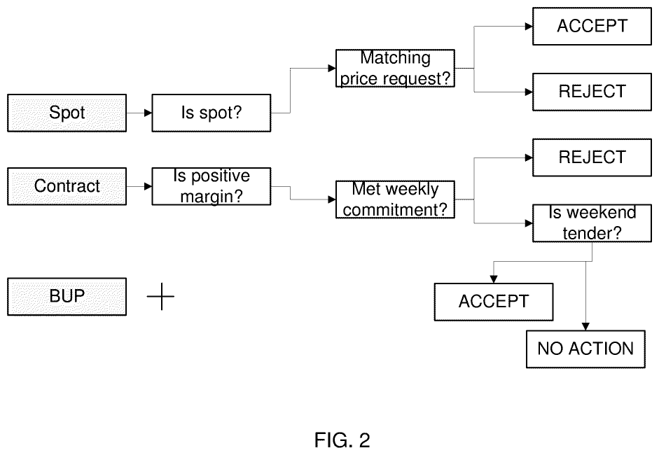

FIG. 2 illustrates an example of a set of decision criteria for accepting or rejecting shipments according to an embodiment. As shown, there are different criteria for each of the three categories of tender offers, “Spot,” “Contract,” and “BUP.” The criteria for the “BUP” category is hidden (selecting the “+” symbol would expand it). The criteria for the other two categories are visible. For “Spot,” the rule “Is spot?” will return true, and is then followed by a “Matching price request” rule. If there was a price request by the broker, which is matched by the tender offer, then the shipment will be accepted. Otherwise, it will be rejected. For “Contract,” the rule “Is positive margin?” will be true if the margin on the shipment is above zero and false otherwise. If false, the action is not shown, but a default action (e.g., reject shipment) may be applied in some embodiments. If true, the rule “Met weekly commitment?” is applied. This checks to see if the broker has met their weekly commitment (e.g., under the contract terms for the particular shipper associated with the shipment). The weekly commitment may refer to a commitment to the shipper to deliver a certain number of shipments in a given week, or it may relate to a commitment to deliver a certain number of shipments of a particular type or sub-type, which could be further specified by parameters specified by the user. If the weekly commitment has been met (the rule returns true), then the shipment is rejected. On the other hand, if the weekly commitment has not been met (the rule returns false), then the next rule “Is weekend tender?” is applied. If true, the shipment is accepted, and if false, the shipment is rejected.

This is an exemplary set of decision criteria for accepting or rejecting shipments (or all shipments from a specific shipper). Fewer rules, or more rules, may be applied depending on the circumstances. For example, a broker may decide to automatically accept (or reject) all spot offers. Or to accept all offers so long as the margin is positive and there is capacity to handle the offer. On the other hand, a broker may have a complex set of rules taking into account business considerations (e.g., margins, contractual requirements), practical considerations (e.g., capacity constraints, hazardous materials), and other considerations.

In embodiments, a broker may have a different set of criteria for accepting or rejecting shipments for every shipper. Alternatively, or in addition, a broker may have a common set of criteria for accepting or rejecting shipments, which may apply to all shippers, or may apply be default to all shippers, with a different set of shipper-specific criteria applied to a subset of shippers.

Some examples of rules, and the attributes those rules are based on, have been provided above. These examples are non-limiting. Other rules, and other attributes, may be used. Indeed, for a given implementation, the set of rules and attributes allowed may change over time, e.g., as new rules or attributes are added. An attribute may be related to the shipment (e.g., does it contain hazardous material?) or to a shipper (e.g., what weekly commitment has been agreed to?). A rule indicates some test applying one or more attributes, which could include a Boolean test of whether the attribute exists or is true (e.g., does a shipment contain hazardous material?), a comparison (e.g., is a margin above a threshold?), or more complicated logic (e.g., applying a Boolean function to a set of KPI measurements). Some additional examples follow.

For a given shipper, there may be a current number of loads per period (e.g., daily, weekly, monthly, quarterly, etc.), and a corresponding limit. A rule based on these attributes may be based on whether the current number of loads per period is less than the limit.

There may be a mileage limit, e.g., per shipper or for the broker as a whole. This could be a daily mileage limit, or a limit over some other interval. This limit may be measured against a number of miles corresponding to the miles required to deliver each of the accepted shipments over the interval (e.g., daily)., for a specific shipper or overall A rule based on the limit could be based on whether a current number of miles has exceeded the mileage limit. Similarly, there may be a rule based on whether the number of miles associated with the tender offer is less than a threshold mileage limit, irrespective of any accumulated total of miles associated with other accepted shipments. Similar to mileage, there may also be a trip time limit, and associated trip time value for a tender offer. A rule may compare a trip time to a threshold for a given tender offer, and/or may compare an accumulated trip time over accepted offers to a threshold.

Other attributes may include whether a BUP tender off has a linehaul rate, and the associated rate; whether a tender offer has a pickup date, and the associated date; whether the tender offer has shipment miles, and the corresponding shipment miles. Rules based on these attributes may consider whether the attribute exists for the tender offer, and/or may compare the attribute value to a threshold or other value. For example, for a pickup date, a rule may consider whether the pickup date is the same day, the next day, the same or next day, or within some other time frame. For a linehaul rate, a rule may consider whether the linehaul spot quote is less than the linehaul rate.

Similarly, an attribute may include a pricing type, and a rule may consider whether the pricing type is variable (or fixed). An attribute may include whether the shipment is a drop shipment (that is, one where a driver may simply “drop” off the trailer/load without having to unpack the contents), and a rule may consider whether the shipment is a drop shipment. An attribute may include whether the shipment is a hazmat shipment (that is, contains hazardous materials), and a rule may consider whether the shipment is a hazmat shipment. An attribute may relate to whether a commitment (e.g., daily, weekly, monthly, etc.) to a particular shipper has been met, and a rule may consider whether the commitment has been met. An attribute may relate to a target margin, and a rule may consider whether the target margin is greater than or equal to a threshold limit. Other attributes and rules may relate to one or more of the following:
Lane Associated?
Matching Price Request?
Pickup Lead Time>=X?
Same Day Matching Price Request?
Shipment Created After X?
Shipper Rate Associated?
Shipper KPI Acceptance<Target %
Under RMS Lane Acceptance Cap
Won Using Dynamic Routing Guide?
Does shipment have?

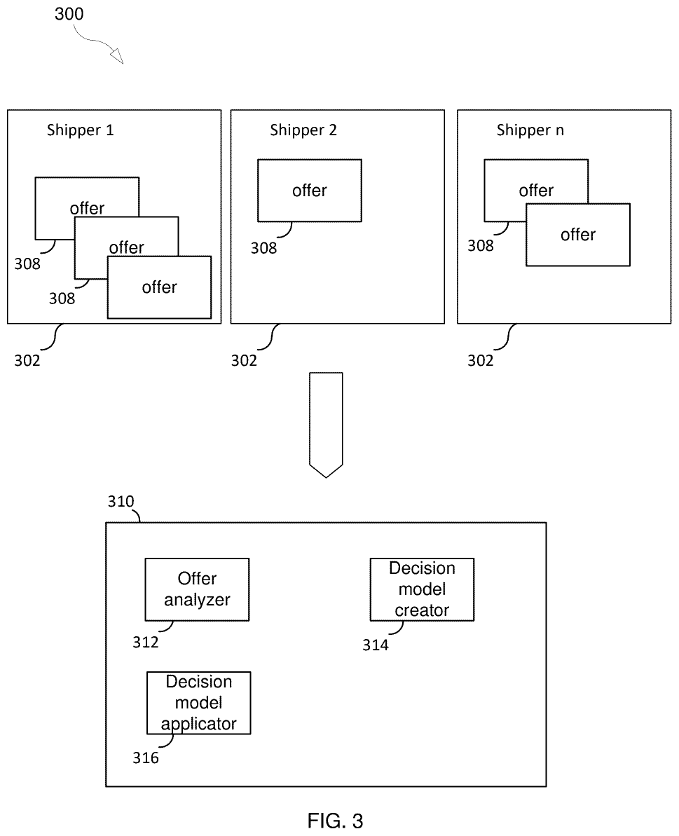

FIG. 3 illustrates a system according to an embodiment. System 300 includes a broker analysis node 310. Broker analysis node receives one or more tender offers 308 from one or more shippers 302, shown exemplarily as Shipper 1, Shipper 2, up to Shipper n. These offers may be communicated with broker analysis node 310, e.g., directly from each shipper, or through some intermediary node. Shipper analysis node 310 may include offer analyzer 312, decision model creator 314, and decision model applicator 316. While this is shown as a single system in the illustration, it is to be understood that each of the components may be implemented separately, on one or more servers, and may reside in the cloud. In some embodiments, a broker may use a third-party provider which provides some or all of the components of broker analysis node 310 on a software-as-a-service model.

Offer analyzer 312 receives the tender offers and analyzes the tender offers as they are received. Offer analyzer 312 may populate attributes about the tender offer, including shipper attributes and shipment attributes, based on this analysis. For example, offer analyzer 312 may record who the shipper is associated with the tender offer, what the shipment rate type is (e.g., spot, contract, or BUP), details about the shipment (e.g., does it contain hazardous material, where is it going, when is the pickup scheduled for, and so on), and other pertinent information that may be used by the decision model applicator 316.

Decision model creator 314 is responsible for creating a decision model from a set of decision criteria. Decision model creator 314 may employ a user interface, such as the user interface 100 discussed above in connection with FIG. 1, to receive input from a user regarding what decision criteria to use. Decision model creator 314 may then use the decision criteria to create the model, e.g., a decision tree model.

Decision model applicator 316 applies the model created by decision model creator 314 to the set of tender offers. For a given offer, the model may be applied immediately, as it is received, or there may be some time delay. For example, there may be a set time period (e.g., 30 minutes) before the offer is applied, or the time period may be user-adjustable. One reason for the delay is that not all of the information that a broker may want to use to make a decision is available as soon as the offer is received. Some data may be calculated separately. So in order to wait for that data to become available, the system can wait before making a decision. Alternatively, or in addition to waiting a fixed time, decision model applicator 316 may wait to apply the model to a given tender offer until all the necessary data to apply the model to that offer are available.

Decision model applicator 316 may apply the model to the tender offers in the same order in which they are received. However, other orderings are also possible in some embodiments. The order in which the model is applied to the offers may matter. For example, given two offers TO1 and TO2, whether a particular cap or commitment has been met when the model is applied to TO1 may depend on whether the model is applied to TO2 first. Similarly, whether the broker has capacity to handle the shipment may depend on the order in which the model is applied to the tender offers. In some embodiments, decision model applicator 316 may apply the model to the tender offers immediately, as soon as they are received, while in other embodiments, decision model applicator 316 may wait and batch process a group of tender offers. For example, decision model applicator 316 may apply the model to tender offers at certain fixed times in the day, after a threshold number of tender offers has been received, and/or some other condition has been met. The order in which the model is applied to the tender offers may be the order in which they are received, or some other order, such as one that favors certain shippers, or high margin shipments, or uses some other sort criteria.

For a given tender offer, after the model has been applied, the broker analysis node 310 may annotate a note associated with the shipment that indicates the results of the model application (e.g., accept, reject, or no action). The note may also include the list of rules followed to arrive at the result, and the value of the corresponding attributes. For example, if one of the rules was that the margin is above a threshold, the note may include both the actual margin and the threshold value it was compared against. In some embodiments, broker analysis node 310 may inform the corresponding shipper the result, indicating, for example, that the shipment is accepted or rejected. In some embodiments, the broker analysis node 310 may wait a set period of time before informing the corresponding shipper of the result, e.g., so that a user may review the results and make manual adjustments as circumstances warrant.

### Creating Rules

The rules that are available for users to select when providing decision criteria may be expanded from time to time. There may be a database where a current set of rules is registered. User interface 100, for example, may access this database when providing the user with options to select from. For some rules, there may be a set of parameters that are passed to the rule when it is being applied to a particular tender offer. These parameters may be necessary for the rule to arrive at a decision. For example, a rule may relate to accepting a shipment if the target margin is greater than a certain amount, where this amount can be controlled by a parameter. When a rule is registered in the database, it can configured with a default parameter which can be overridden when configuring the rule for a certain shipper and a shipment type.

The table which contains the registered rules may look as follows:

TABLE
name: auto_accept_reject_rules

| id | function_name | type | description | parameters |
|---|---|---|---|---|
| 3 | respond_true | respond_to_tender | Respond to tender | |
| 4 | respond_false | respond_to_tender | Do not respond to tender | |
| 5 | enqueue_in_minutes | enqueue_time_in_minutes | Grace period of 1 hour | (“enqueue_time_in_minutes”: 60} |
| 6 | transition_to_on_hold | accept_state_event | Transitions to ‘On Hold’ | |
| 7 | transition_to_cancel | reject_state_event | Transitions to ‘Canceled’ | |
| 8 | weekly_volume_accepted | recommended_action | Accept if weekly volume is | |
| | | | not met | |
| 9 | is_price_match | recommended_action | Accept if Price Request is | |
| | | | found | |
| 10 | target_margin_gt | recommended_action | Accept if target margin is | {“target_margin”: 100} |
| | | | greater than a certain amount | |
| 11 | hazmat | recommended_action | Reject Haz-Mat | |
| 12 | daily_accepted_lt | recommended_action | Accept if daily accepted is | {“num_accepted”: 10} |
| | | | less than a certain number | |

A brief explanation of each column:
id: Unique identifier for a rule which is used to configure it for a shipper.
function_name: The name of the function to look for in the codebase.
type: This corresponds to different types of functionalities provided by an auto accept/reject helper. Possible Types:
   respond_to_tender
   enqueue_time_in_minutes
   accept_state_event
   reject_state_event
   recommended_action
description: The text that can be surfaced to the UI.
parameters (optional): The default parameters for the rule.

### Configuring Rules

Once a set of rules are registered, each shipper may be mapped with rules based on the required outcomes for a certain shipment type. This may be based on a user inputting decision criteria, e.g., through user interface 100 described above with respect to FIG. 1. The decision model creator 314, described above with respect to FIG. 3, may create this mapping. The rules may be stored in a table, which stores the configuration for each shipper and the type of shipment. Along with the mapping between a shipper and a rule, default parameters for a given rule may also be overridden, and the table may store the desired action to be taken when the rules returns true/false (or if not strictly a binary decision, the table may store the desired action to be taken on other return values).

A simple mapping between a shipper and the rule may be used to apply a single rule to a shipment. For more complex logic to be applied to a shipment, multiple rules in a sequence may be chained together. Based on the outcome of one rule, another rule may be invoked, until reaching an end result (e.g., accept, reject, or no action). In some embodiments, there may be a limit to the number of rules that may be chained together for a particular shipper. The rules for a particular shipper may also be stored in a database.

When configuring the rules, a validation may be performed to validate the rules. For example, the validation may check for any cycles in the configuration, and may check if there are any unreachable rules. In either case, the user may in embodiments be prompted to address the issue.

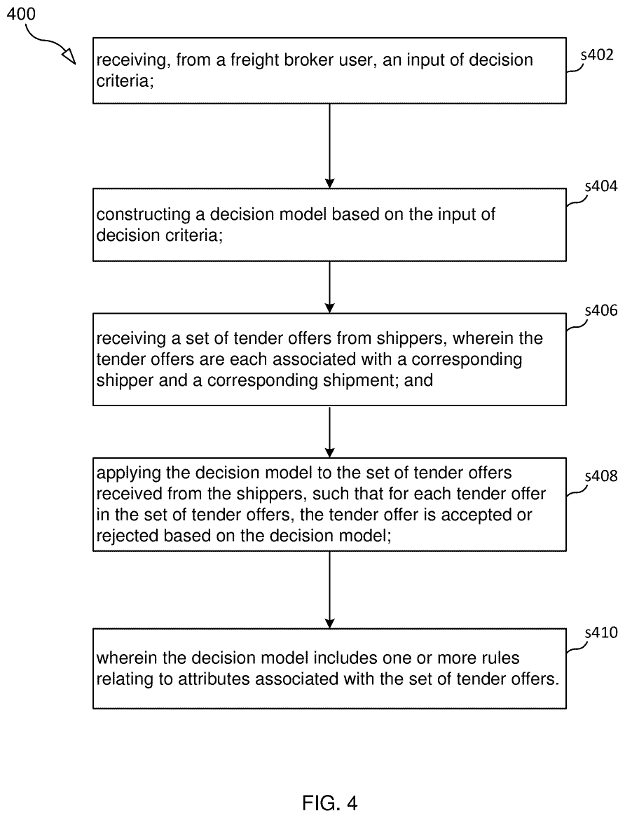

FIG. 4 is a flowchart illustrating a process 400 for automating shipment decisions, according to an embodiment. Process 400 may be performed by broker analysis node 310. Process 400 may begin in step s402.

Step s402 comprises receiving, from a freight broker user, an input of decision criteria. As described above with respect to FIG. 1, this input of decision criteria may be by a user using user interface 100.

Step s404 comprises constructing a decision model based on the input of decision criteria. As described above with respect to FIG. 3, this may be a decision model created by decision model creator 314.

Step s406 comprises receiving a set of tender offers from shippers. The tender offers are each associated with a corresponding shipper and a corresponding shipment. As described above with respect to FIG. 3, the tender offers may include tender offers 308 from one or more shippers 302.

Step s408 comprises applying the decision model to the set of tender offers received from the shippers, such that for each tender offer in the set of tender offers, the tender offer is accepted or rejected based on the decision model. As described above with respect to FIG. 3, the application of the model to the tender offers may be performed by decision model applicator 316.

Step s410 comprises, wherein the decision model includes one or more rules relating to attributes associated with the set of tender offers.

In some embodiments, the one or more rules relating to attributes associated with the set of tender offers are in an hierarchical tree-like arrangement and applying the decision model to the set of tender offers received from the shippers comprises applying the one or more rules in an order based on the hierarchical tree-like arrangement. In some embodiments, the method further includes receiving additional input of additional decision criteria after constructing the decision model, and re-constructing the decision model based on the additional decision criteria. In some embodiments, the method further includes, after constructing the decision model, displaying a graphical representation of the decision model to the freight broker user. In some embodiments, the one or more rules relating to attributes associated with the set of tender offers includes one or more of the following: (a) a rule relating to a type of the tender offer, wherein the type is one or more of a contract offer, a spot offer, and a backup offer; (b) a rule relating to a projected profit margin associated with the tender offer; (c) a rule relating to a rate type associated with the tender offer; and (d) a rule relating to carrier capacity relative to a projected capacity associated with the tender offer. In some embodiments, the one or more rules relating to attributes associated with the set of tender offers includes a rule relating to a key performance indicator (KPI) associated with the corresponding shipper.

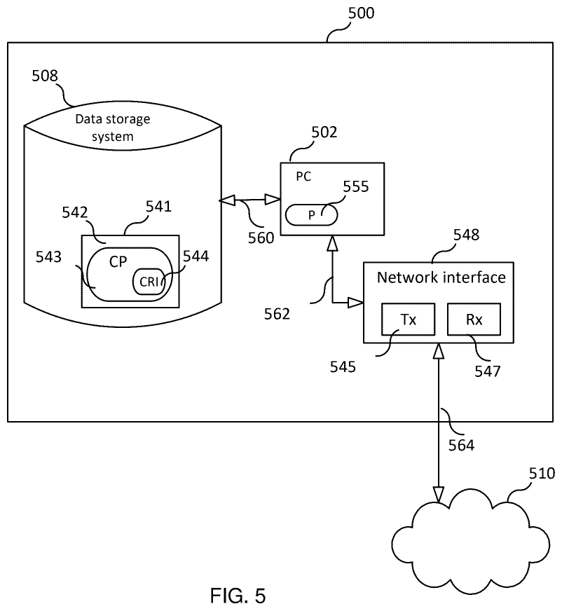

FIG. 5 is a block diagram of apparatus 500 (e.g., broker analysis node 310), according to some embodiments, for performing the methods disclosed herein. As shown in FIG. 5, apparatus 500 may comprise: processing circuitry (PC) 502, which may include one or more processors (P) 555 (e.g., a general purpose microprocessor and/or one or more other processors, such as an application specific integrated circuit (ASIC), field-programmable gate arrays (FPGAs), and the like), which processors may be co-located in a single housing or in a single data center or may be geographically distributed (i.e., apparatus 500 may be a distributed computing apparatus); at least one network interface 548 comprising a transmitter (Tx) 545 and a receiver (Rx) 547 for enabling apparatus % 00 to transmit data to and receive data from other nodes connected to a network 510 (e.g., an Internet Protocol (IP) network) to which network interface 548 is connected (directly or indirectly) (e.g., network interface 548 may be wirelessly connected to the network 510, in which case network interface 548 is connected to an antenna arrangement); and a storage unit (a.k.a., “data storage system”) 508, which may include one or more non-volatile storage devices and/or one or more volatile storage devices. Interface 560 may connect PC 502 and storage unit 508, interface 562 may connect PC 502 and network interface 548, and interface 564 may connect network interface 548 and network 510. In embodiments where PC 502 includes a programmable processor, a computer program product (CPP) 541 may be provided. CPP 541 includes a computer readable medium (CRM) 542 storing a computer program (CP) 543 comprising computer readable instructions (CRI) 544. CRM 542 may be a non-transitory computer readable medium, such as, magnetic media (e.g., a hard disk), optical media, memory devices (e.g., random access memory, flash memory), and the like. In some embodiments, the CRI 544 of computer program 543 is configured such that when executed by PC 502, the CRI causes apparatus 500 to perform steps described herein (e.g., steps described herein with reference to the flow charts). In other embodiments, apparatus 500 may be configured to perform steps described herein without the need for code. That is, for example, PC 502 may consist merely of one or more ASICs. Hence, the features of the embodiments described herein may be implemented in hardware and/or software.

While various embodiments are described herein, it should be understood that they have been presented by way of example only, and not limitation. Thus, the breadth and scope of this disclosure should not be limited by any of the above described exemplary embodiments. Moreover, any combination of the above-described embodiments in all possible variations thereof is encompassed by the disclosure unless otherwise indicated herein or otherwise clearly contradicted by context.

Additionally, while the processes described above and illustrated in the drawings are shown as a sequence of steps, this was done solely for the sake of illustration. Accordingly, it is contemplated that some steps may be added, some steps may be omitted, the order of the steps may be re-arranged, and some steps may be performed in parallel.

1. A method for automating shipment decisions, the method comprising:
receiving, from a freight broker user, an input of decision criteria;
constructing a decision model based on the input of decision criteria;
receiving a set of tender offers from shippers, wherein the tender offers are each associated with a corresponding shipper and a corresponding shipment; and
applying the decision model to the set of tender offers received from the shippers, such that for each tender offer in the set of tender offers, the tender offer is accepted or rejected based on the decision model;
wherein the decision model includes one or more rules relating to attributes associated with the set of tender offers.

2. The method of claim 1, wherein the one or more rules relating to attributes associated with the set of tender offers are in an hierarchical tree-like arrangement and applying the decision model to the set of tender offers received from the shippers comprises applying the one or more rules in an order based on the hierarchical tree-like arrangement.

3. The method of claim 1, further comprising, receiving additional input of additional decision criteria after constructing the decision model, and re-constructing the decision model based on the additional decision criteria.

4. The method of claim 1, further comprising, after constructing the decision model, displaying a graphical representation of the decision model to the freight broker user.

5. The method of claim 1, wherein the one or more rules relating to attributes associated with the set of tender offers includes one or more of the following:
(a) a rule relating to a type of the tender offer, wherein the type is one or more of a contract offer, a spot offer, and a backup offer;
(b) a rule relating to a projected profit margin associated with the tender offer;
(c) a rule relating to a rate type associated with the tender offer; and
(d) a rule relating to carrier capacity relative to a projected capacity associated with the tender offer.

6. The method of claim 1, wherein the one or more rules relating to attributes associated with the set of tender offers includes a rule relating to a key performance indicator (KPI) associated with the corresponding shipper.

7. A node comprising:
processing circuitry; and
a memory, the memory containing instructions executable by the processing circuitry, whereby when executed the processing circuitry is configured to:
receive, from a freight broker user, an input of decision criteria;
construct a decision model based on the input of decision criteria;
receive a set of tender offers from shippers, wherein the tender offers are each associated with a corresponding shipper and a corresponding shipment; and
apply the decision model to the set of tender offers received from the shippers, such that for each tender offer in the set of tender offers, the tender offer is accepted or rejected based on the decision model;
wherein the decision model includes one or more rules relating to attributes associated with the set of tender offers.

8. The node of claim 7, wherein the one or more rules relating to attributes associated with the set of tender offers are in an hierarchical tree-like arrangement and applying the decision model to the set of tender offers received from the shippers comprises applying the one or more rules in an order based on the hierarchical tree-like arrangement.

9. The node of claim 7, further comprising, receiving additional input of additional decision criteria after constructing the decision model, and re-constructing the decision model based on the additional decision criteria.

10. The node of claim 9, further comprising, after constructing the decision model, displaying a graphical representation of the decision model to the freight broker user.

11. The node of claim 7, wherein the one or more rules relating to attributes associated with the set of tender offers includes one or more of the following:
(a) a rule relating to a type of the tender offer, wherein the type is one or more of a contract offer, a spot offer, and a backup offer;
(b) a rule relating to a projected profit margin associated with the tender offer;
(c) a rule relating to a rate type associated with the tender offer; and
(d) a rule relating to carrier capacity relative to a projected capacity associated with the tender offer.

12. The node of claim 7, wherein the one or more rules relating to attributes associated with the set of tender offers includes a rule relating to a key performance indicator (KPI) associated with the corresponding shipper.
